(19) United States
(12) Patent Application Publication
(10) Pub. No.: US 2014/0215295 A1
(43) Pub. Date: Jul. 31, 2014

(54) THREE-DIMENSIONAL IMAGE DISPLAYING SYSTEM AND METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/053,593

(22) Filed: Oct. 14, 2013

(30) Foreign Application Priority Data
Jan. 29, 2013 (CN) 2013100332360

(51) Int. Cl. G06F 17/21

(52) U.S. Cl. CPC G06F 17/212
USPC 715/202

(57) ABSTRACT

A computer inserts a 3D image file into a webpage, and inserts a 3D image into the 3D image file. The computer generates a control file and associates the control file with the 3D image file. The computer displays the 3D image in a webpage and operating the 3D image by invoking the control file when the webpage is accessed.

### BACKGROUND

1. Technical Field

The embodiments of the present disclosure relate to webpage technology, and particularly to a system and method of displaying a three-dimensional image in a webpage.

2. Description of Related Art

Electronic commerce is a booming business on the Internet. Additionally, it is necessary to show pictures of the products on a webpage of an electronic commerce website, so that the consumer can see the products. However, most pictures are bitmaps, such as graphics interchange format (GIF) or joint photographic experts group (JPEG) pictures, which are two-dimensional images. Therefore, there is room for improvement in the art for displaying 3D images in the webpage.

### BRIEF DESCRIPTION OF THE DRAWINGS

FIG. 1 is a block view of one embodiment of a computer including a three-dimensional image displaying system.

FIG. 2 is a block diagram of one embodiment of function modules of the three-dimensional image displaying system in FIG. 1.

FIG. 3 is a flowchart of one embodiment of a three-dimensional image displaying method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

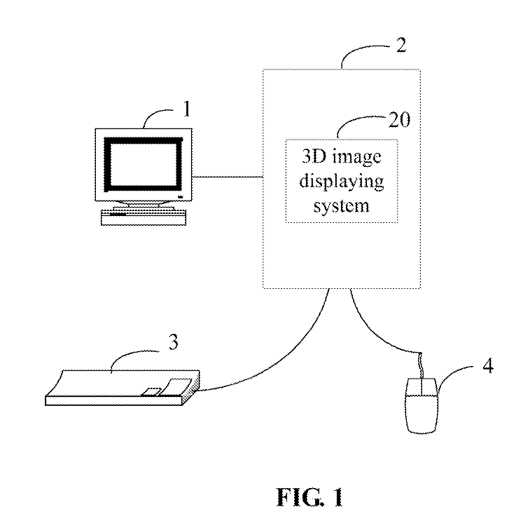

FIG. 1 is a block diagram of one embodiment of a computer 2. In this embodiment, the computer 2 includes a three-dimensional (3D) image displaying system 20. A plurality of peripherals are electronically connected to the computer 2, such as a display device 1, a keyboard 3, and a mouse 4. The peripherals may be used to input or output various computer signals or interfaces.

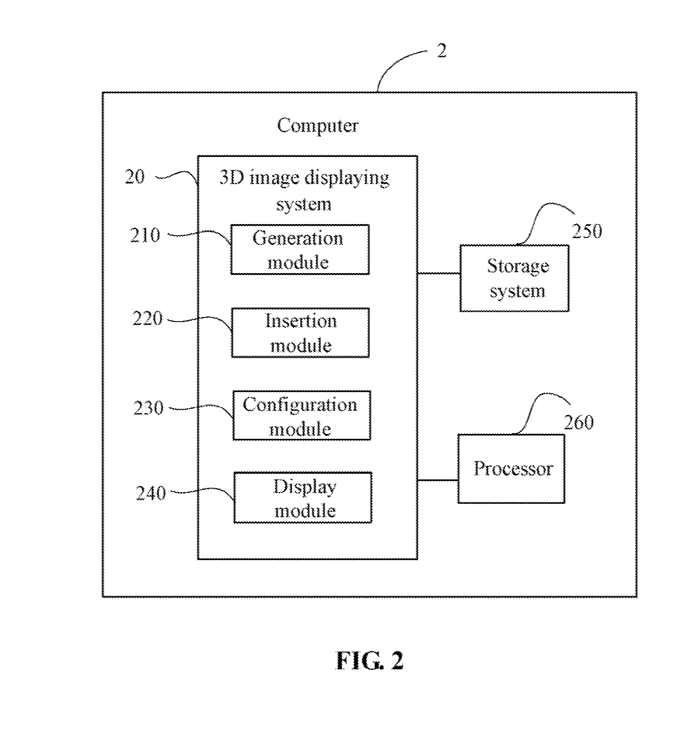

FIG. 2 is a block diagram of one embodiment of function modules of the 3D image displaying system 20 included in the computer 2 of FIG. 1. The 3D image displaying system 20 is used to display a 3D image in a webpage. In one embodiment, the computer 2 includes a storage system 250 and at least one processor 260. In one embodiment, the 3D image displaying system 20 includes a generation module 210, an insertion module 220, a configuration module 230, and a display module 240. The modules 210-240 may include computerized code in the form of one or more programs that are stored in the storage system 250. The computerized code includes instructions that are executed by the at least one processor 260 to provide functions for the modules 210-240. The storage system 250 may be a memory, such as an EPROM memory chip, hard disk drive (HDD), or flash memory stick.

The generation module 210 generates the webpage and a 3D image file. The webpage may be, but is not limited to, an active server pages (ASP) webpage, a JAVA server pages (JSP) webpage, a hypertext preprocessor (PHP) webpage, or a hypertext markup language (HTML) webpage. The 3D image file may be, but is not limited to, a TXT file or a scalable vector graphics (SVG) file. In one embodiment, the generation module 210 invokes a file editor (e.g., MICROSOFT VISUAL STUDIO) to generate the webpage and the 3D image file.

The insertion module 220 inserts the 3D image file into the webpage. To enhance a scalability of the webpage, the webpage provides one or more tags for extension. The insertion module 220 searches for a tag in the webpage and inserts the 3D image file into the webpage at a position of the tag in the webpage. For example, the ASP webpage provides three tags, such as, iframe, embed and object. The insertion module 220 searches for the iframe in the ASP webpage and inserts the 3D image file at the position of the iframe in the webpage.

The configuration module 230 configures the 3D image file and inserts a 3D image into the 3D image file. The 3D image file is configured with a background layer, a canvas layer, one or more displaying layers and one or more shadow layers. The background layer obtains event responses from the keyboard 3 and the mouse 4 and operates the 3D image, such as, drags the 3D image, zooms in the 3D image, zooms out the 3D image, or rotates the 3D image. The canvas layer is embedded into the background layer, and displays the 3D image. The canvas layer displays the 3D image using a DOM (a tag of SVG). One or more displaying layers are embedded into the canvas layer and each displaying layer includes one 3D image. In other words, the configuration module 230 inserts the 3D image into the displaying layer. One or more shadow layers are embedded into the displaying layer, and each displaying layer may include one or more shadow layers. Each shadow layer helps to create a shadow around the 3D image when the 3D image is displayed on the display device 1. Additionally, it is an option to include one or more shadow layers in the webpage. In other words, the one or more shadow layers are not necessary in the webpage.

The 3D image is inserted into the displaying layer of the 3D image file using a link. For example, if the 3D image is the link, the configuration module 230 inserts the link into a position of a link attribute (e.g., xlink:href) of the displaying layer. The configuration module 230 can draw the 3D image in the displaying layer of the 3D image file. In one embodiment, the configuration module 230 establishes a coordinate system in the displaying layer and draws the 3D image in the DOM of the 3D image file. The configuration module 230 also sets attribute of the 3D image, for example, a color of the 3D image or a name of the 3D image.

The generation module 210 generates a control file and associates the control file with the 3D image file. The control file can drag the 3D image, zoom in the 3D image, zoom out the 3D image, or rotate the 3D image. The control file may be, but is not limited to, a JAVASCRIPT (JS) file. The control file is associated with the 3D image file using an event. In one embodiment, the background layer of the 3D image file is added by the event, and the control file is added by a function of the event, then the control file is associated with the 3D image file. The function of the event in the control file is invoked when the 3D image file runs. For example, if the background layer is added by the event “onload=Initialize(evt),” and the control file is added by the function of the event “Initialize(evt),” the control file is associated with 3D image file. “Initialize(evt)” in the control file is invoked when the 3D image file runs to “onload=Initialize(evt). Additionally, the background layer is added by one or more events, and the control file is added by the function of each event. For example, if a user desires to drag the 3D image using the mouse 4, the background layer is added by the event “onload=MouseDown(evt),” and the control file is added by the function of the event “MouseDown(evt).”

The display module 240 displays the 3D image in the webpage and operates the 3D image by invoking the control file when the webpage is accessed. In one embodiment, when the user accesses the webpage using the browser, the display module 240 checks that the webpage includes the 3D image file, and the 3D image can be operated using the control file when the 3D file runs.

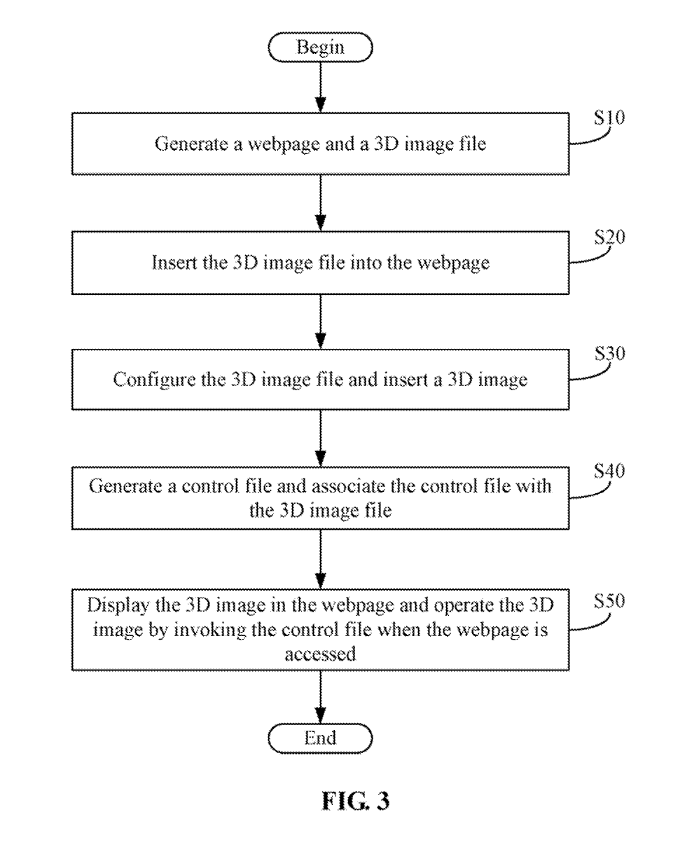

FIG. 3 is a flowchart of one embodiment of a 3D image displaying method. Depending on the embodiment, additional steps may be added, others deleted, and the ordering of the steps may be changed.

In step S10, the generation module 210 generates a webpage and a 3D image file. As mentioned above, the generation module 210 invokes a file editor (e.g., MICROSOFT VISUAL STUDIO) to generate the webpage and the 3D image file.

In step S20, the insertion module 220 inserts the 3D image file into the webpage. In one embodiment, if the webpage is an ASP webpage, the insertion module 220 searches for the iframe in the ASP webpage and inserts the 3D image file at the position of the iframe in the webpage.

In step S30, the configuration module 230 configures the 3D image file and inserts a 3D image into the 3D image file. As mentioned above, the 3D image file is configured with a background layer, a canvas layer, one or more displaying layers and one or more shadow layers. The configuration module 230 inserts the 3D image into the displaying layer of the 3D image file using a link. For example, if the 3D image is the link, the configuration module 230 inserts the link into a position of a link attribute (e.g., xlink:href) of the displaying layer. The configuration module 230 can draw the 3D image in the displaying layer of the 3D image file instead of the link. In one embodiment, the configuration module 230 establishes a coordinate system in the displaying layer and draws the 3D image in the DOM of the 3D image file. The configuration module 230 also sets attribute of the 3D image, for example, a color of the 3D image or a name of the 3D image. The attribute of the 3D image can be searched by a search engine.

In step S40, the generation module 210 generates a control file and associates the control file with the 3D image file. The control file can drag the 3D image, zoom in the 3D image, zoom out the 3D image, or rotate the 3D image. The control file may be, but is not limited to, a JAVASCRIPT (JS) file. The control file is associated with the 3D image file using one or more events. In one embodiment, the background layer of the 3D image file is added by the event, and the control file is added by a function of the event, then the control file is associated with the 3D image file. The function of the event in the control file is invoked when the 3D image file runs. For example, if the background layer is added by the event “onload=Initialize(evt),” and the control file is added by the function of the event “Initialize(evt)” in the JS file, the control file is associated with 3D image file. “Initialize(evt)” in the control file is invoked when the 3D image file runs to “onload=Initialize(evt). Additionally, the background layer is added by one or more events, and the control file is added by the function of each event. For example, if a user desires to drag the 3D image using the mouse 4, the background layer is added by the event “onload=MouseDown(evt),” and the control file is added by the function of the event “MouseDown(evt).”

In step S50, the display module 240 displays the 3D image in the webpage and operates the 3D image by invoking the control file when the webpage is accessed. In one embodiment, when the user accesses the webpage using the browser, the display module 240 checks that the webpage includes the 3D image file, and the 3D image can be operated using the control file when the 3D image is displayed on the display device 1. For example, when the user uses the mouse 4 to drag the 3D image, the control file executes the function of event for dragging, and sends the event response to the background layer of the 3D image file, then the 3D image is dragged to a desired position.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
at least one processor; and
a storage system that stores one or more programs, when executed by the at least one processor, causing the at least one processor to perform a three-dimensional (3D) image displaying method, the method comprising:
generating a webpage and a 3D image file;
inserting the 3D image file into the webpage;
configuring the 3D image file and inserting a 3D image into the 3D image file;
generating a control file and associating the control file with the 3D image file; and
displaying the 3D image in the webpage and operating the 3D image by invoking the control file when the webpage is accessed.

2. The computer of claim 1, wherein the 3D image file is inserted into a position of a tag in the webpage.

3. The computer of claim 1, wherein the 3D image file is configured with a background layer, a canvas layer, one or more displaying layers and one or more shadow layers.

4. The computer of claim 3, wherein the background layer obtains event responses from a keyboard and a mouse and operates the 3D image.

5. The computer of claim 3, wherein the canvas layer is embedded into the background layer, and displays the 3D image.

6. The computer of claim 3, wherein the one or more displaying layers are embedded into the canvas layer and each displaying layer comprises one 3D image.

7. The computer of claim 3, wherein the one or more shadow layers are embedded into the displaying layer, and each shadow layer helps to create a shadow around the 3D image when the 3D image is displayed on a display device of the computer.

8. The computer of claim 3, wherein the 3D image is inserted into the displaying layer of the 3D image file using a link.

9. The computer of claim 3, wherein the 3D image is drawn in the displaying layer of the 3D image file.

10. The computer of claim 1, wherein the control file is associated with the 3D image file using an event.

11. A 3D image displaying method implemented by a computer, the method comprising:
generating a webpage and a 3D image file by the computer;
inserting the 3D image file into the webpage by the computer;
configuring the 3D image file and inserting a 3D image into the 3D image file by the computer; generating a control file and associating the control file with the 3D image file by the computer; and
displaying the 3D image in the webpage and operating the 3D image by invoking the control file by the computer when the webpage is accessed.

12. The method of claim 11, wherein the 3D image file is inserted into a position of a tag in the webpage.

13. The method of claim 11, wherein the 3D image file is configured with a background layer, a canvas layer, one or more displaying layers and one or more shadow layers.

14. The method of claim 13, wherein the background layer obtains event responses from a keyboard and a mouse and operates the 3D image.

15. The method of claim 13, wherein the canvas layer is embedded into the background layer, and displays the 3D image.

16. The method of claim 13, wherein the one or more displaying layers are embedded into the canvas layer and each displaying layer comprises one 3D image.

17. The method of claim 13, wherein the one or more shadow layers are embedded into the displaying layer, and each shadow layer helps to create a shadow around the 3D image when the 3D image is displayed on a display device of the computer.

18. The method of claim 13, wherein the 3D image is inserted into the displaying layer of the 3D image file using a link.

19. The method of claim 13, wherein the 3D image is drawn in the displaying layer of the 3D image file.

20. The method of claim 11, wherein the control file is associated with the 3D image file using an event.
